(19) United States
(12) Patent Application Publication
(10) Pub. No.: US 2020/0197259 A1
(43) Pub. Date: Jun. 25, 2020

(54) VENTILATION SYSTEM FOR SALON TREATMENT ASSEMBLY

(71) Applicant: EARTHLITE, LLC, Vista, CA (US)

(72) Inventor: Richard Estrada, Oceanside, CA (US)

(21) Appl. No.: 16/696,266

(22) Filed: Nov. 26, 2019

Related U.S. Application Data
(60) Provisional application No. 62/784,245, filed on Dec. 21, 2018.

(51) Int. Cl. A61H 35/00; A47C 7/50

(52) U.S. Cl. CPC A61H 35/006; A47C 7/5062

(57) ABSTRACT

A salon treatment assembly (10) includes a salon chair (12) that supports the user during the salon treatment; and a foot bath system (14) that is coupled to the salon chair (12). The foot bath system (14) includes (i) a foot bath (15) that is configured to receive and retain a bath liquid (15A); and (ii) a ventilation system (16) that includes a vent inlet (16A) that is coupled to the foot bath (15), and a vacuum source (61) that creates at least a partial vacuum in the vent inlet (16A) to draw gas away from near the foot bath (15).

### RELATED APPLICATION

This application claims priority on U.S. Provisional Application No. 62/784,245 filed on Dec. 21, 2018, and entitled “VENTILATION SYSTEM FOR SALON TREATMENT ASSEMBLY”. As far as permitted, the contents of U.S. Provisional Application No. 62/784,245 are incorporated herein.

### BACKGROUND

As the benefits of various salon treatments are becoming more widely appreciated, more and more people are choosing to receive salon treatments. One such popular salon treatment is the pedicure, which helps people to improve the appearance of their feet and toe nails. A salon treatment assembly, e.g., a pedicure treatment assembly, that may be used when a person is receiving a pedicure can include a salon chair, e.g., a pedicure chair, where the person receiving the pedicure is seated, and a foot bath where certain features of the pedicure are performed. Unfortunately, the products and/or chemicals used during a pedicure, e.g., nail polish, nail polish remover, etc., can subject both the pedicure provider and the person receiving the pedicure to many unpleasant, hazardous and/or noxious fumes.

### SUMMARY

The present invention is directed toward a salon treatment assembly for use by a user during a salon treatment, such as a pedicure. In various embodiments, the salon treatment assembly includes a salon chair and a foot bath system. The salon chair supports the user during the salon treatment. The foot bath system is coupled to the salon chair. The foot bath system includes (i) a foot bath that is configured to receive and retain a bath liquid, and (ii) a ventilation system that is coupled to the foot bath, the ventilation system being configured to draw gases away from near the foot bath system. In one embodiment, the ventilation system draws air away from a front of the foot bath system. Thus, the ventilation system can draw air away from the sensory systems, e.g., olfactory systems, visual systems, etc., of the treatment provider and the user receiving the pedicure.

In some embodiments, the foot bath is movably coupled to the salon chair so that the foot bath is selectively moved between an extended configuration, where the foot bath is at least substantially uncovered by the salon chair, and a retracted configuration, where the foot bath system is at least substantially covered by the salon chair. In certain such embodiments, the salon treatment assembly further includes a foot bath mover assembly that selectively moves the foot bath relative to the salon chair between the extended configuration and the retracted configuration. Additionally, in such embodiments, the foot bath mover assembly can include (i) a fixed based member that is fixed in position relative to the salon chair, (ii) a movable base member that is coupled to the foot bath, (iii) a guide that is positioned along the fixed base member and guides movement of the movable base member relative to the fixed base member, and (iv) a mover that selectively moves the movable base member relative to the fixed base member.

Additionally, in certain embodiments, the ventilation system includes (i) a vent assembly that receives the air into the ventilation system, and (ii) a conduit assembly that is coupled to the vent assembly. In such embodiments, the conduit assembly is configured to guide (pull) the air from the front of the foot bath through the salon treatment assembly before the air is exhausted away from a rear of the salon chair. The ventilation system can further include a vacuum source that is coupled in fluid communication to the conduit assembly. The vacuum source is configured to draw the air into the vent assembly.

In some embodiments, the conduit assembly includes a first conduit that is coupled to the vent assembly, and a second conduit that is fixedly coupled to the salon chair. Additionally, the second conduit is coupled to the first conduit. In certain such embodiments, the second conduit is movably coupled to the first conduit. For example, the second conduit can be movably coupled to the first conduit in a telescoping manner. Further, in such embodiments, the first conduit is movable relative to the second conduit between an extended position and a retracted position. When the foot bath system is in the extended configuration, the first conduit is in the extended position relative to the second conduit. Conversely, when the foot bath system is in the retracted configuration, the first conduit is in the retracted position relative to the second conduit.

The conduit assembly can further include a seal that seals the movable coupling between the first conduit and the second conduit.

Additionally, in some embodiments, the conduit assembly further includes a vent coupling assembly that couples the first conduit to the vent assembly.

In another configuration, the present invention is directed to a method for supporting a user during a salon treatment comprising: (i) providing a salon chair that supports the user during the salon treatment; and (ii) coupling a foot bath system to the salon chair. The foot bath system can include a foot bath that is configured to receive and retain a bath liquid; and a ventilation system that includes a vent inlet that is coupled to the foot bath, and a vacuum source that creates at least a partial vacuum in the vent inlet to draw gas away from near the foot bath.

Additionally, the method can include moving the foot bath relative to the salon chair between an extended configuration in which the foot bath is substantially uncovered by the salon chair, and a retracted configuration in which the foot bath is substantially covered by the salon chair.

In yet another embodiment, the salon treatment assembly includes: a salon chair that supports the user during the salon treatment; and a foot bath system coupled to the salon chair. The foot bath system can include (i) a foot bath that is configured to receive and retain a bath liquid, and (ii) a ventilation system that includes a vent inlet that is coupled to the foot bath, and a vacuum source that creates at least a partial vacuum in the vent inlet to draw gas away from near the foot bath. The foot bath can be movable relative to the salon chair between an extended configuration in which the foot bath is substantially uncovered by the salon chair, and a retracted configuration in which the foot bath is substantially covered by the salon chair. Further, the ventilation system can include a retractable conduit assembly that connects the vent inlet to the vacuum source in fluid communication while the foot bath is moved between configurations.

The foot bath can include a bath front and a bath rear, the bath rear being closer to the salon chair than bath front when the foot bath is in the extended configuration, and wherein the vent inlet is positioned adjacent to the bath front to draw gas into the vent inlet near the bath front.

The conduit assembly can include a first conduit that is coupled to the vent inlet, and a second conduit that is fixedly coupled to the salon chair. Further, the second conduit can be coupled to the first conduit in a telescoping manner.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a front perspective view illustration of an embodiment of a salon treatment assembly having features of the present invention, the salon treatment assembly including a salon chair and a foot bath system, with the foot bath system being in an extended configuration;

FIG. 1B is a front perspective view illustration of the salon treatment assembly illustrated in FIG. 1A, with the foot bath system being in a retracted configuration;

FIG. 1C is a side view illustration of the salon treatment assembly illustrated in FIG. 1A, with the foot bath system being in the extended configuration;

FIG. 1D is a rear perspective view illustration of a portion of the salon treatment assembly illustrated in FIG. 1A, with the foot bath system being in the retracted configuration;

FIG. 1E is a rear perspective view illustration of a portion of the salon treatment assembly illustrated in FIG. 1A, with the foot bath system being in a partially extended configuration;

FIG. 2 is a front perspective view illustration of the foot bath system illustrated in FIG. 1A, the foot bath system including a ventilation system;

FIG. 3A is a front perspective view illustration of an embodiment of the ventilation system; and

FIG. 3B is an exploded view illustration of the ventilation system illustrated in FIG. 3A.

### DESCRIPTION

Embodiments of the present invention are described herein in the context of a salon treatment assembly including a salon chair and a foot bath system that is selectively movable relative to the salon chair. In various embodiments, the foot bath system includes a ventilation system that draws gases (e.g. air), and thus any potentially hazardous and/or noxious fumes generated during the salon treatment, e.g., a pedicure, away from the treatment provider as well as the person receiving the treatment. More particularly, in various embodiments, the ventilation system includes a vacuum source that pulls the gases, e.g., including hazardous and/or noxious fumes, away from a bath front of the foot bath system, and thus away from the sensory systems of the treatment provider and the person receiving the treatment.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar nomenclature and/or reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

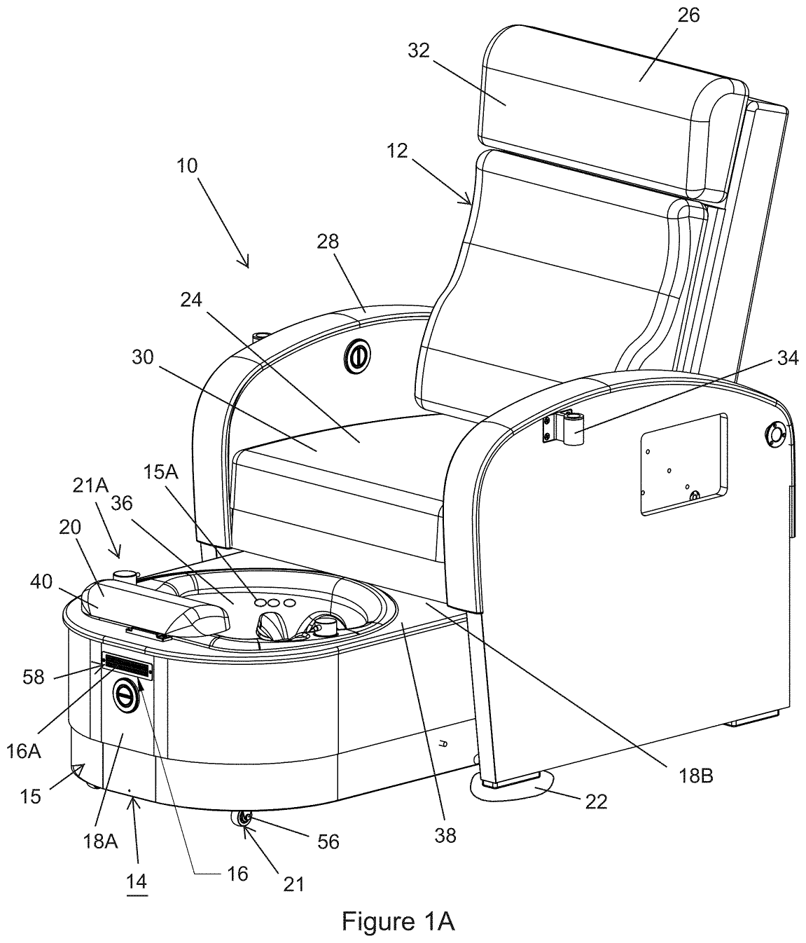

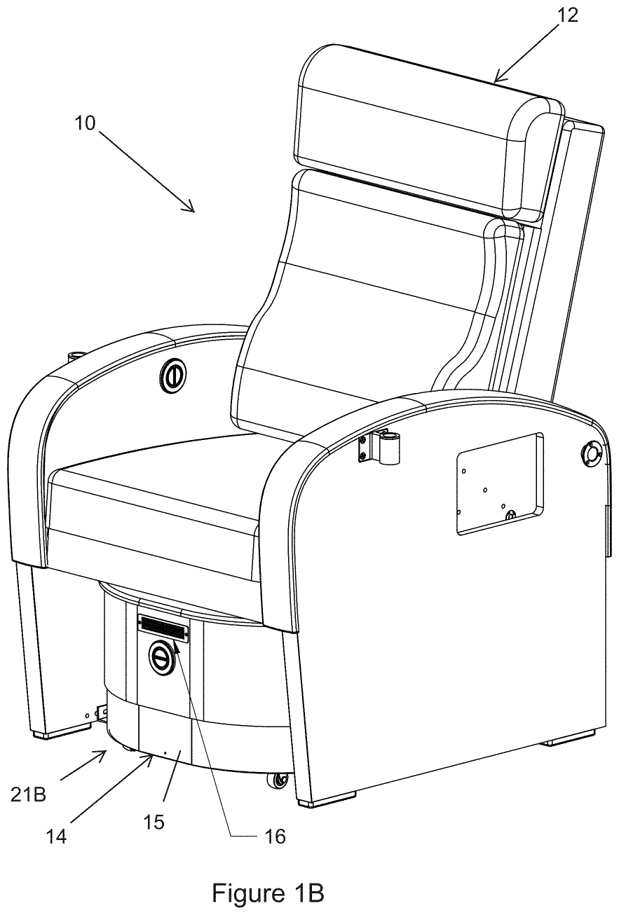

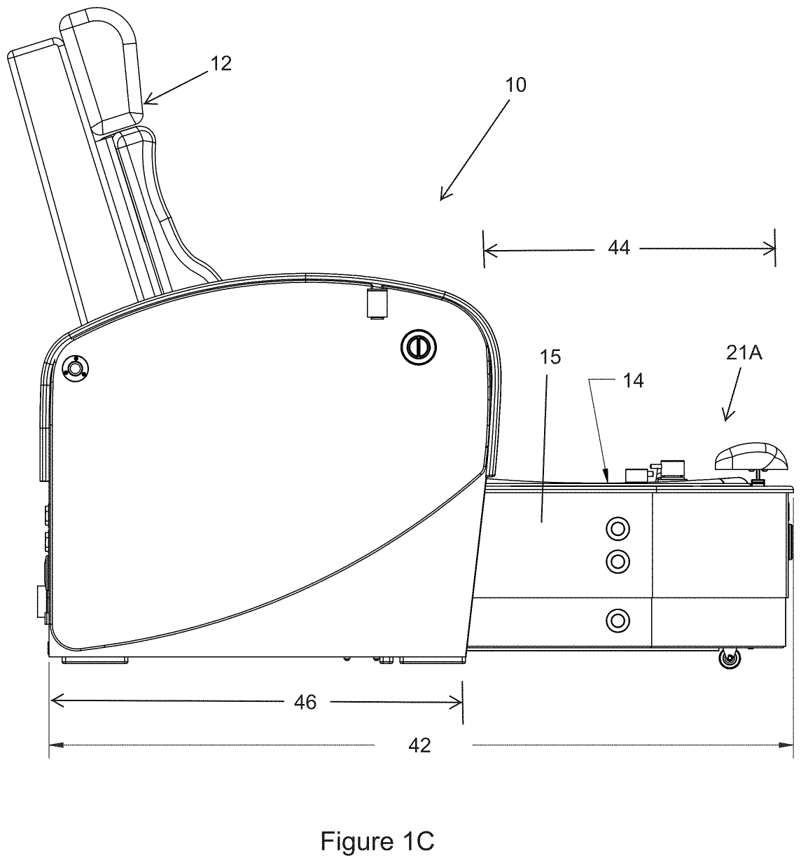

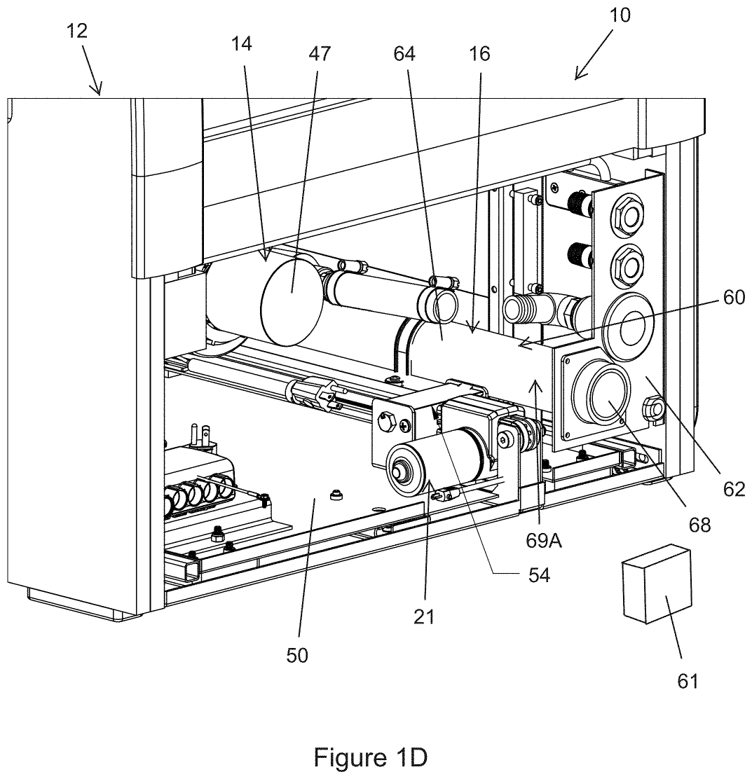

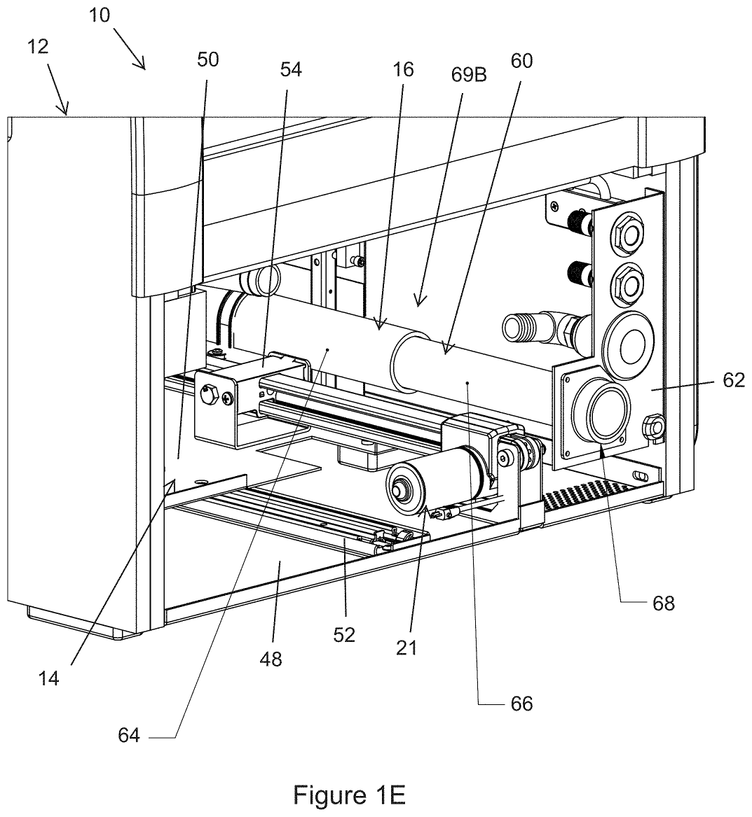

FIG. 1A is a front perspective view illustration of an embodiment of a salon treatment assembly 10 having features of the present invention. The design of the salon treatment assembly 10 can be varied. In certain embodiments, as illustrated in FIG. 1A, the salon treatment assembly 10 includes a salon chair 12, e.g., a pedicure chair, and a foot bath system 14. Alternatively, the salon treatment assembly 10 can have a different design, e.g., can have more or fewer components than what is specifically illustrated in FIG. 1A. For example, in one non-exclusive alternative embodiment, the salon treatment assembly 10 can further include a stool system, which can provide a place for the treatment provider to be positioned, e.g., seated, while providing a salon treatment, e.g., a pedicure, and/or can provide an alternative device on which the person receiving the treatment can rest their legs and/or feet during the salon treatment.

As an overview, in certain embodiments, the salon treatment assembly 10, e.g., the foot bath system 14, is uniquely designed to remove any potentially hazardous and/or noxious fumes (gases) away from the treatment provider and the person receiving the treatment during the salon treatment. More specifically, in such embodiments, the foot bath system 14 can include a foot bath 15 that is configured to receive and retain a bath liquid 15A (illustrated with three small ovals) and a ventilation system 16, that is configured to remove and/or draw gases (e.g. air), including potentially hazardous and/or noxious fumes, away from near the foot bath 15. With this design, any hazardous and/or noxious fumes from the bath liquid 15A is removed by the ventilation system 16. This protects both the person receiving the treatment (i.e. pedicure), and the person performing the treatment.

The foot bath 15 includes a bath front 18A and a bath rear 18B. Further, the foot bath 15 can optionally include a foot rest 20 where the person receiving the salon treatment can rest their feet during the salon treatment. In FIG. 1A, the foot rest 20 is positioned near the bath front 18A so that the person performing the treatment has easy access to the feet of the person receiving the treatment. Typically, the person performing the procedure is positioned near the bath front 18A during the procedure.

In certain embodiments, the ventilation system 16 can include a vent inlet 16A that functions as the inlet to draw the gases away from near the foot bath 15. In FIG. 1A, the vent inlet 16A is fixedly coupled to and extends through the foot bath 15. More specifically, in FIG. 1A, the vent inlet 16A is positioned at or adjacent to the bath front 18A. With this design, the ventilation system 16 draws the gases away from the bath front 18A.

Additionally, in some embodiments, there is relative movement between the foot bath 15 and the salon chair 12. For example, the foot bath 15 can be selectively movable relative to the salon chair 12, e.g., with a foot bath mover assembly 21, between an extended configuration 21A (as shown in FIG. 1A), where the foot bath 15 is substantially uncovered by the salon chair 12, and a retracted configuration 21B (as shown in FIG. 1B), where the foot bath 15 is substantially covered by the salon chair 12. As used herein, in the extended configuration 21A, substantially uncovered shall mean that at least fifty percent of the foot bath 15 is not covered by the salon chair 12, and in the retracted configuration 21B, substantially covered shall mean that at least fifty percent of the foot bath 15 is covered by the salon chair 12.

In the non-exclusive embodiment illustrated in FIG. 1A, in the extended configuration 21A, almost the entire foot bath 15 is not covered by the salon chair 12. Further, in the non-exclusive embodiment illustrated in FIG. 1B, in the retracted configuration 21B, almost the entire foot bath 15 is covered by the salon chair 12. Stated in another fashion, in the extended configuration 21A almost the entire foot bath 15 is extended away from the salon chair 12, and in the retracted configuration 21B, almost the entire foot bath 15 is retracted under the salon chair 12.

It should be noted that for reference, (i) in the extended configuration 21A, the bath rear 18B is closer to the salon chair 12 than bath front 18A, and (ii) in the retracted configuration 21B, both the bath rear 18B and bath front 18A can be positioned under the salon chair 12.

In one non-exclusive embodiment, the salon chair 12 can be fixed and stationary relative to a surface 22, e.g., a floor or the ground, and the foot bath 15 can be selectively movable along the surface 22 and relative to the salon chair 12 between the extended configuration 21A and the retracted configuration 21B. With such design, the salon treatment assembly 10 can have a much smaller overall footprint when not being used and/or when the foot bath system 14 is not be utilized. It is appreciated, however, that the salon chair 12 need not be fixed in position relative to the surface 22 for the use of the present invention. For example, in one non-exclusive alternative embodiment, the salon treatment assembly 10 can be configured such that the salon chair 12 is selectively movable relative to the foot bath 15. It is further appreciated that the foot bath 15 can be selectively positioned anywhere between the retracted configuration 21B and the extended configuration 21A to better suit the size or height of the person receiving the salon treatment. Stated in another manner, the foot bath 15 can be positioned in any suitable intermediate configuration, i.e. partially extended and/or partially retracted, to better suit the person receiving the salon treatment. Still further, the adjustability of the position of the foot bath 15 relative to the salon chair 12 can make it much easier for the person receiving the salon treatment to get into the salon chair 12 prior to treatment and out of the salon chair 12 after treatment.

Further, in some embodiments, the foot bath 15 is fixedly, yet movably, coupled to the salon chair 12. With such design, the entirety of the salon treatment assembly 10 can be moved together from one location to another, but the foot bath 15 can still be selectively moved relative to the salon chair 12, i.e. relative to at least a majority of the salon chair 12, between the extended configuration 21A and the retracted configuration 21B. Alternatively, the foot bath system 14 can be provided separately and/or independently from the salon chair 12.

The salon chair 12, e.g., a pedicure chair, is designed to support a person relative to the surface 22 while the person is receiving a salon treatment, e.g., a pedicure treatment. The size, shape, dimensions and design of the salon chair 12 can be varied as desired, e.g., for various functional and/or aesthetic reasons. As shown in FIG. 1A, the salon chair 12 can include a seat support 24, a back support 26, and chair arms 28. The design of each of these components can be varied depending on the specific requirements of the salon treatment assembly 10. Alternatively, the salon chair 12 can have a different design than that illustrated in FIG. 1A. For example, in one non-exclusive alternative embodiment, the salon chair 12 can be designed without the chair arms 28.

The seat support 24 supports the backside of the person receiving the salon treatment when the person is positioned on the salon chair 12. The design of the seat support 24 can be varied to suit the specific requirements of the salon chair 12 and/or for the comfort of the person receiving the salon treatment. In certain embodiments, the seat support 24 includes a seat support base (not illustrated), a seat pad (not illustrated) that is positioned on the seat support base, and a seat pad cover 30 that is positioned over the seat pad and secures the seat pad to the seat support base. Alternatively, for example, the seat support 24 can be made without the seat pad and/or the seat pad cover 30.

The seat support base is generally rigid and can be made of a rigid material such as wood, aluminum, plastic, or other suitable materials. In certain non-exclusive, alternative embodiments, the seat support base can have a thickness of approximately 0.50, 0.75, 1.00, 1.25, 1.50, 1.75, 2.00, 2.25 or 2.50 centimeters. However, other thicknesses for the seat support base can also be utilized.

The seat pad provides a cushion for the comfort of the person seated on the salon chair 12. Non-exclusive examples of suitable materials for the seat pad include foam, memory foam, fleece pads, etc. Additionally, the seat pad can be made any desired thickness.

The seat pad cover 30 secures the seat pad to the seat support base and provides a protective covering for the seat pad. Non-exclusive examples of suitable materials for the seat pad cover 30 include leather, vinyl, plastic, and cloth.

The back support 26 can support the back of the person receiving the salon treatment when the person is positioned on the salon chair 12. The design of the back support 26 can be varied to suit the specific requirements of the salon chair 12 and/or for the comfort of the person receiving the salon treatment. In certain embodiments, the back support 26 includes a back support base (not illustrated), a back pad (not illustrated) that is positioned on the back support base, and a back pad cover 32 that is positioned over the back pad and secures the back pad to the back support base. Alternatively, for example, the back support 26 can be made without the back pad and/or the back pad cover 32.

The back support base is generally rigid and can be made of a rigid material such as wood, aluminum, plastic, or other suitable materials. In certain non-exclusive, alternative embodiments, the back support base has a thickness of approximately 0.50, 0.75, 1.00, 1.25, 1.50, 1.75, 2.00, 2.25 or 2.50 centimeters. However, other thicknesses for the back support base can also be utilized.

The back pad provides a cushion for the comfort of the person seated on the salon chair 12. Non-exclusive examples of suitable materials for the back pad include foam, memory foam, fleece pads, etc. Additionally, the back pad can be made any desired thickness.

The back pad cover 32 secures the back pad to the back support base and provides a protective covering for the back pad. Non-exclusive examples of suitable materials for the back pad cover 32 include leather, plastic, and cloth.

Additionally, in some embodiments, the back support 26 can be adjustably, e.g., hingedly, secured and/or coupled to the seat support 24 such that the back support 26 can be rotated, i.e. tilted (reclined), relative to the seat support 24. Alternatively, the salon chair 12 can be designed so that the back support 26 does not tilt relative to the seat support 24.

The chair arms 28 can support the arms of the person receiving the salon treatment when the person is positioned on the salon chair 12. The design of the chair arms 28 can be varied to suit the specific requirements of the salon chair 12 and/or for the comfort of the person receiving the salon treatment. For example, in certain alternative embodiments, the chair arms 28 can be fixed and stationary relative to the rest of the salon chair 12, or the chair arms 28 can be adjustable in position relative to the rest of the salon chair 12.

In one embodiment, as illustrated, the salon chair 12 can include one or more tray supports 34 that can be used to support a hand tray (not shown) when desired, e.g., when the person seated in the salon chair 12 is receiving a manicure. In this embodiment, the tray supports 34 are coupled and/or secured to an outside edge of the chair arms 28. Alternatively, the tray supports 34 can be positioned on the salon chair 12 in a different position and/or in a different manner.

As noted above, in various embodiments, the foot bath system 14 can be movably coupled to the salon chair 12. The size, shape, dimensions and design of the foot bath system 14, and the various components of the foot bath system 14, can be varied as desired, e.g., for various functional and/or aesthetic reasons. As illustrated in FIG. 1A, the foot bath 15 defines a reservoir 36 that receives and retains the bath liquid 15A. Further, the foot bath 15 can include a ledge 38 that is positioned around a top of the foot bath 15. In this embodiment, the foot rest 20 can be coupled to the foot bath 36 and/or the ledge 38 near the bath front 18A and the vent inlet 16A.

Additionally, the foot bath system 14 can include the foot bath mover assembly 21, and the ventilation system 16. Alternatively, the foot bath system 14 can have a different design. For example, the foot bath system 14 can be designed without the foot rest 20 and/or the foot bath 15 can be moved manually.

The foot bath 15 provides a place for the person receiving the salon treatment to place their feet, e.g., during portions of a pedicure treatment. Additionally, the foot bath 15 can be configured to receive and retain bath liquid 15A (e.g. water or other fluid) during the pedicure treatment. For example, in one embodiment, the foot bath 15 can include (i) a fluid control mechanism (not shown), which controls the adding of a volume of hot and/or cold bath liquid 15A to the reservoir 36 by selectively turning on the hot and/or cold water; and (ii) a drain control mechanism (not shown), which controls the removal, i.e. draining, of a volume of the bath liquid 15A from the foot bath 16 by selectively opening a drain (not shown) at a base of the foot bath 15. It should be appreciated that the fluid control mechanism and the drain control mechanism can be positioned in any suitable location for purposes of providing the desired control of adding water to and/or draining water from the foot bath 15. Alternatively, the foot bath 15 can be configured such that such that bath liquid 15A has to be manually added to and/or removed from the foot bath 18.

As provided above, the foot rest 20 can be coupled to the foot bath 15 and/or the ledge 38 that is positioned around the top of the foot bath 15. Additionally, as noted, the foot rest 20 can give the person receiving the salon treatment a place to rest their feet during the salon treatment. The foot rest 20 can have any suitable design. In certain embodiments, the foot rest 20 includes a foot rest base (not illustrated), a foot rest pad (not illustrated) that is positioned on the foot rest base, and a foot rest pad cover 40 that is positioned over the foot rest pad and secures the foot rest pad to the foot rest base. Alternatively, for example, the foot rest 20 can be made without the foot rest pad and/or the foot rest pad cover 40.

The foot rest base is generally rigid and can be made of a rigid material such as wood, aluminum, plastic, or other suitable materials. In certain non-exclusive, alternative embodiments, the foot rest base has a thickness of approximately 0.50, 0.75, 1.00, 1.25, 1.50, 1.75, 2.00, 2.25 or 2.50 centimeters. However, other thicknesses for the foot rest base can also be utilized.

The foot rest pad provides a cushion for the legs and/or feet of the person seated on the salon chair 12. Non-exclusive examples of suitable materials for the foot rest pad include foam, memory foam, fleece pads, etc. Additionally, the foot rest pad can be made any desired thickness.

The foot rest pad cover 40 secures the foot rest pad to the foot rest base and provides a protective covering for the foot rest pad. Non-exclusive examples of suitable materials for the foot rest pad cover 40 include leather, plastic, and cloth.

Additionally, in some embodiments, the foot rest 20 can be height adjustable to better suit the comfort of the person receiving the salon treatment. More particularly, in such embodiments, the foot rest 20 can be selectively moved to different heights relative to the foot bath 36 and/or the ledge 38.

The foot bath mover assembly 21, as noted, is configured to selectively move the foot bath 15 relative to the salon chair 12 between the extended configuration 21A and the retracted configuration 21B. The foot bath mover assembly 21 can have any suitable design for purposes of moving the foot bath system 14 relative to the salon chair 12 as desired. Certain embodiments of the foot bath mover assembly 21 will be described in greater detail herein below.

Additionally, as provided herein, the ventilation system 16 is configured to remove and/or draw gases, including potentially hazardous and/or noxious fumes, away from the bath front 18A of the foot bath 15, e.g., away from the foot rest 20. Embodiments of the ventilation system 16 will be described in greater detail herein below.

FIG. 1B is a front perspective view illustration of the salon treatment assembly 10 illustrated in FIG. 1A. As noted above, in FIG. 1B, the foot bath 15 of the foot bath system 14 has been moved relative to the salon chair 12 so that the foot bath 15 is in the retracted configuration 21B relative to the salon chair 12. In such configuration, the foot bath 15 is at least substantially covered by the salon chair 12. Additionally, as illustrated, FIG. 1B again shows a portion of the ventilation system 16 of the foot bath system 14.

FIG. 1C is a side view illustration of the salon treatment assembly 10 illustrated in FIG. 1A, with the foot bath system 14 being in the extended configuration relative to the salon chair 12.

FIG. 1C illustrates certain, non-exclusive, dimensions of the salon treatment assembly 10. More specifically, FIG. 1C illustrates an overall length 42, i.e. from front-to-back, of the salon treatment assembly 10, i.e. when the salon treatment assembly 10 is in the extended configuration 21A. In certain non-exclusive embodiments, the salon treatment assembly 10 can have an overall length 42 that is between approximately one hundred twenty centimeters and one hundred sixty centimeters. Alternatively, the salon treatment assembly 10 can have an overall length 42 that is greater than approximately one hundred sixty centimeters or less than approximately one hundred twenty centimeters.

Additionally, FIG. 1C also illustrates an extended length 44 of the foot bath 15 of the foot bath system 14, i.e. the amount that the foot bath 15 extends in the forward direction away from the salon chair 12 when the foot bath 15 is in the extended configuration 21A. In some non-exclusive embodiments, the foot bath 15 can have an extended length 44 that is between approximately forty-five centimeters and seventy-five centimeters. Alternatively, the foot bath 15 can have an extended length 44 that is greater than approximately seventy-five centimeters or less than approximately forty-five centimeters.

Further, FIG. 1C also illustrates a chair length 46, i.e. from front-to-back, of the salon chair 12. It is appreciated that the chair length 46 is approximately equal to the overall length 42 of the salon treatment assembly 10 less the extended length 44 of the foot bath system 14. Additionally, it is further appreciated that the chair length 46 can be equal to a retracted length of the salon treatment assembly 10, i.e. the length of the salon treatment assembly 10 when the foot bath 15 is fully retracted so as to be fully covered by the salon chair 12. In certain non-exclusive embodiments, the salon chair 12 can have a chair length 46 that is between approximately seventy-five centimeters and one hundred fifteen centimeters. Alternatively, the salon chair 12 can have a chair length 46 that is greater than approximately one hundred fifteen centimeters or less than approximately seventy-five centimeters.

FIG. 1D is a rear perspective view illustration of a portion of one embodiment of the salon treatment assembly 10. In the configuration shown in FIG. 1D, the foot bath system 14 is in the retracted configuration relative to the salon chair 12. In FIG. 1D, a portion of a fluid access pipe 47 of the foot bath system 14 is shown. In certain embodiments, the fluid access pipe 47 can be used for providing water to the foot bath 15 (illustrated in FIG. 1A) and/or removing water from the foot bath 15. Additionally, or in the alternative, the fluid access pipe 47 can be used to provide air into the foot bath 15, e.g., to create bubbles within the foot bath 15.

FIG. 1E is another rear perspective view illustration of a portion of the salon treatment assembly 10 illustrated in FIG. 1A. In the configuration shown in FIG. 1E, the foot bath system 14 is in an intermediate configuration, i.e. partially retracted and/or partially extended, relative to the salon chair 12. In such configuration, the foot bath 15 is not directly visible in FIG. 1E.

As shown, FIG. 1D and FIG. 1E illustrate certain features of the foot bath mover assembly 21 and the ventilation system 16.

As noted herein, the foot bath mover assembly 21 is configured to selectively move the foot bath 15 relative to the salon chair 12 between the extended configuration 21A (illustrated in FIG. 1A) and the retracted configuration 21B (illustrated in FIG. 1B). The foot bath mover assembly 21 can have any suitable design. For example, in certain embodiments, the foot bath mover assembly 21 can include one or more of a fixed base member 48 (illustrated in FIG. 1E), a movable base member 50, one or more guides 52 (illustrated in FIG. 1E), a mover 54, and one or more wheels 56 (a portion of two wheels are illustrated in FIG. 1A). Alternatively, the foot bath mover assembly 21 can have more components or fewer components than those specifically illustrated and described herein.

The fixed base member 48 can be a thin plate-like member that is fixed in position relative to the salon chair 12 and provides a base for movement of the foot bath 15 relative to the salon chair 12.

The movable base member 50 can also be a thin plate-like member that is coupled to the foot bath 15 and moves with the foot bath 15.

As shown in FIG. 1E, the guide 52 is positioned along the fixed base member 48 and guides movement of the movable base member 50 relative to the fixed base member 48. More particularly, in one embodiment, the guide 52 is oriented from back-to-front along the fixed based member 48 to guide linear movement of the foot bath 15 relative to the salon chair 12. In such embodiment, the movable base member 50 movably engages the guide 52, and moves along the guide 52 as the foot bath 15 is moved relative to the salon chair 12. Thus, with such design, the movable base member 50 can be said to be movably coupled to the fixed base member 48.

The mover 54 selectively moves the movable base member 50, and thus the foot bath system 14, relative to the fixed base member 48, i.e. along the guide 52. In one non-exclusive embodiment, the mover 54 can be a linear actuator that moves the movable base member 50, and thus the foot bath system 14, linearly between the extended configuration 21A and the retracted configuration 21B. Alternatively, the mover 54 can have another suitable design.

The wheels 56 are positioned to engage the surface 22 (illustrated in FIG. 1A) and support at least a portion of the foot bath 15 relative to the surface 22. During movement of the foot bath 15 relative to the salon chair 12 between the extended configuration 21A and the retracted configuration 21B, the wheels 56 are configured to roll along the surface 22.

The ventilation system 16 is coupled to the foot bath 15. Additionally, as provided herein, the ventilation system 16 is configured to remove and/or draw gases, including potentially hazardous and/or noxious fumes, away from the bath front 18A (illustrated in FIG. 1A) of the foot bath 15, e.g., away from the foot rest 20 (illustrated in FIG. 1A) where the person receiving the salon treatment can rest their feet during the salon treatment.

The design of the ventilation system 16 can be varied. In some embodiments, the ventilation system 16 can include a vent assembly 58 (illustrated in FIG. 1A) having at least one vent inlet 16A (illustrated in FIG. 1A), a conduit assembly 60 (only a portion of which is visible in FIG. 1D and FIG. 1E) that is coupled to the vent assembly 58, and a vacuum source 61 (illustrated as a box in FIG. 1D) that is coupled in fluid communication to the conduit assembly 60. For example, the vacuum source 61 can be a vacuum pump.

The vent assembly 58 provides an access point for the gases, including potentially hazardous and/or noxious fumes, to be drawn into and/or enter the ventilation system 16. For example, in some embodiments, the vacuum source 61 can pull at least a partial vacuum through the conduit assembly 60 and the vent assembly 58 so as to create a low pressure area near the vent assembly 58 and near the bath front 18A of the foot bath 15. With such design, the low pressure area created by use of the vacuum source 61 naturally draws any gases near the vent assembly 58 into the vent assembly 58 so that is can be directed away from the treatment provider and the person receiving the salon treatment.

As noted, the conduit assembly 60 is coupled to the vent assembly 58 and connects the vent assembly 58 in fluid communication with the vacuum source 61. Additionally, the conduit assembly 60 provides an assembly through which the gases are guided from the bath front 18A of the foot bath 15 through the salon treatment assembly 10, before being exhausted away from a rear 62 of the salon treatment assembly 10 and/or the salon chair 12. Alternatively, for example, one or more additional conduits can be used to exhaust the gases outside or to another location.

In one non-exclusive embodiment, the conduit assembly 60 can include a first conduit 64, a second conduit 66 (illustrated in FIG. 1E) and an outlet 68. In certain embodiments, the first conduit 64 and the second conduit 66 are movably coupled to one another in a telescoping manner, and the outlet 68 is in fluid communication with the vacuum source 61 so that the vacuum source 61 can create at least a partial vacuum in the conduits 64, 66. In one embodiment, at least one of the conduits 64, 66 is retractable and slidable relative to the other conduit 64, 66.

Further, the first conduit 64 can be fixedly coupled to the foot bath 15 and move with the foot bath 15. Additionally, the second conduit 66 can be fixedly coupled to the salon chair 12, e.g. fixedly secured at or near the rear 62 of the salon chair 12. Further, the second conduit 66 can define the outlet 68 that is in fluid communication with the vacuum source 61. With such design, during movement of the foot bath 15 relative to the salon chair 12, the second conduit 66 is fixed in position relative to the salon chair 12. However, the first conduit 64 moves relative to the second conduit 66 in such telescoping manner so as to selectively adjust an overall length of the conduit assembly 60. Stated in another manner, as the foot bath 15 is selectively moved between the retracted configuration 21B and the extended configuration 21A, the first conduit 64 is moved relative to the second conduit 66 between (i) a retracted position 69A (illustrated in FIG. 1D), wherein the second conduit 66 is positioned substantially inside the first conduit 64 (and the first conduit 64 substantially encircles the second conduit 66); and (ii) an extended position 69B (illustrated in FIG. 1E), wherein the first conduit 64 at least partly extends away from the second conduit 66. Thus, through the relative movement between the first conduit 64 and the second conduit 66, the conduit assembly 60 is able to maintain the desired coupling between the vent assembly 58 and the vacuum source 61 regardless of whether the foot bath 15 is in the retracted configuration 21B or the extended configuration 21A.

It is appreciated that the reference to a first conduit and a second conduit is merely for convenience and ease of reference, and either conduit 64, 66 can be referred to as the “first conduit” and/or the “second conduit”.

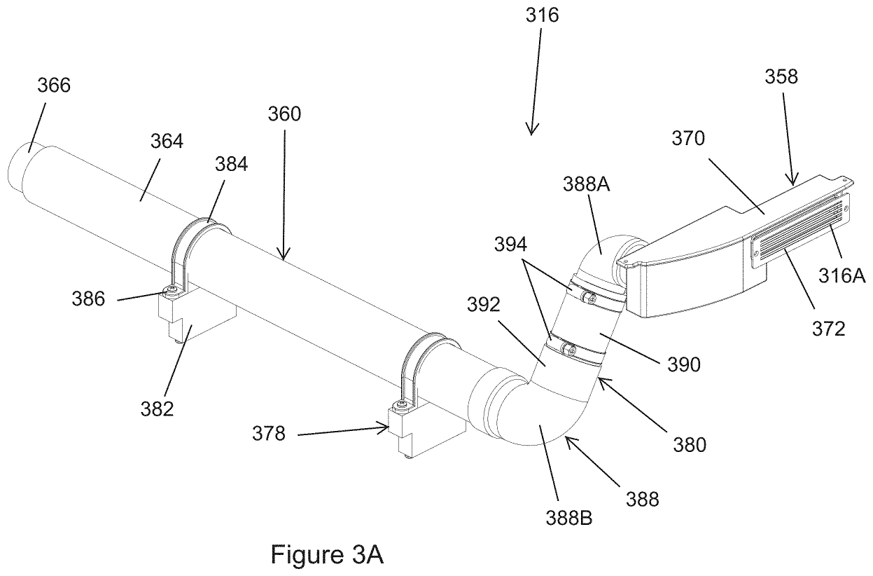

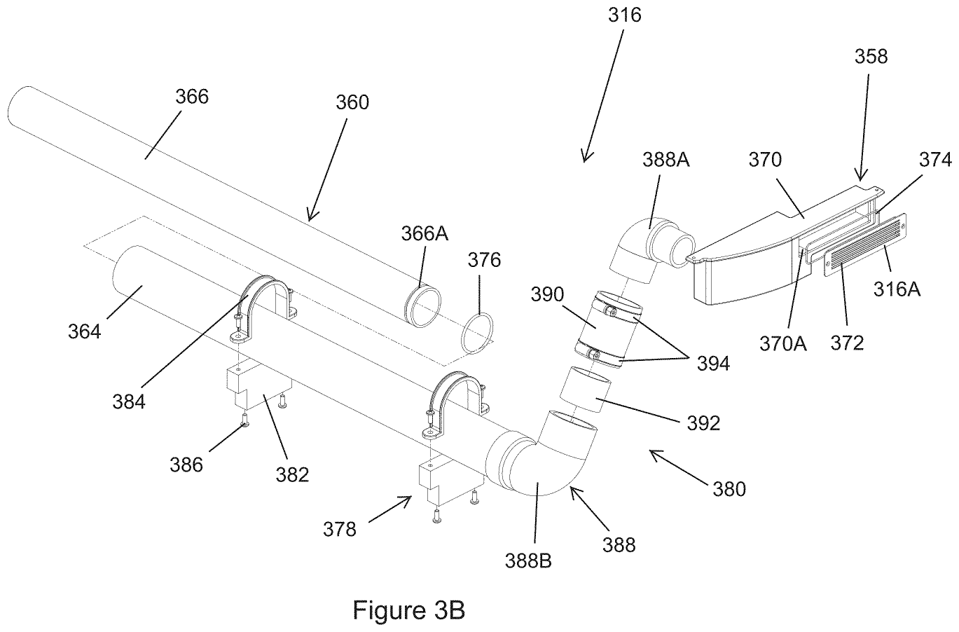

Embodiments of the ventilation system 16 will be described in greater detail herein below in relation to FIGS. 3A and 3B.

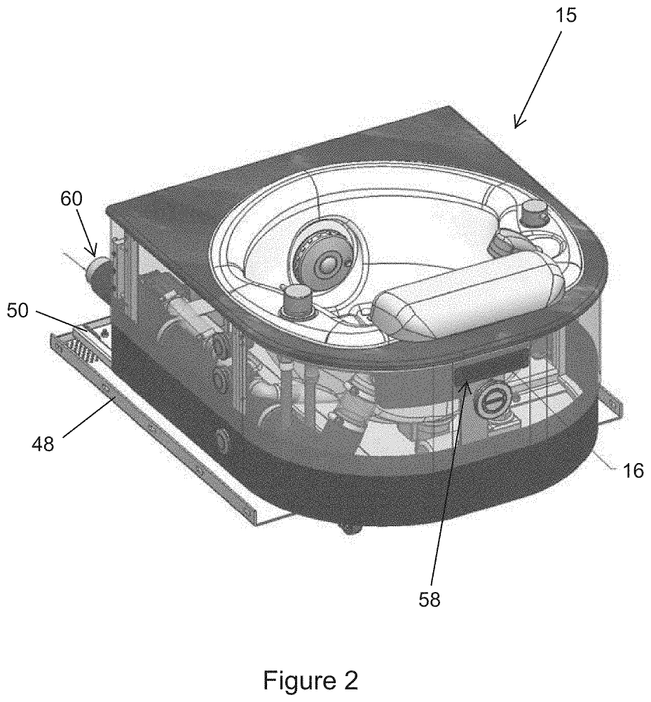

FIG. 2 is a front perspective view illustration (with partial see through) of the foot bath 15 illustrated in FIG. 1A. It should be noted that the fixed base member 48, and the movable base member 50 are also illustrated. As shown in FIG. 2, a portion of the foot bath 15 is provided in a translucent manner so as to better illustrate a positioning of the ventilation system 16, i.e. the vent assembly 58 and the conduit assembly 60.

FIG. 3A is a front perspective view illustration of a non-exclusive embodiment of the ventilation system 316. Additionally, FIG. 3B is an exploded view illustration of the ventilation system 316 illustrated in FIG. 3A.

The design of the ventilation system 316 can be varied. In certain embodiments, as noted above, the ventilation system 316 can include a vent assembly 358 including the vent inlet 316A, and a conduit assembly 360. It is appreciated that the design of the each of these components can be varied to suit the requirements of the salon treatment assembly 10 (illustrated in FIG. 1A). Additionally, as provided herein, the ventilation system 316 can also include the vacuum source 61 (illustrated in FIG. 1D), which can pull a vacuum through the conduit assembly 360 and the vent assembly 358 so as to create a low pressure area outside the vent assembly 358 and near the bath front 18A (illustrated in FIG. 1A) of the foot bath 15 (illustrated in FIG. 1A). With such design, the low pressure area created by use of the vacuum source 61 naturally draws any gases near the vent assembly 358 into the vent assembly 358 so that is can be directed through the conduit assembly 360 and out through the outlet 68 (illustrated in FIG. 1D) at or near the rear 62 (illustrated in FIG. 1D) of the salon treatment assembly 10 or elsewhere. Thus, the gases can be directed away from the treatment provider and the person receiving the salon treatment.

The vent assembly 358 provides the air intake for the ventilation system 316. In certain embodiments, as shown in FIGS. 3A and 3B, the vent assembly 358 can include a vent body 370, a vent screen 372 and a vent seal 374. Alternatively, the vent assembly 358 can include more components or fewer components than what is illustrated and described herein.

The vent body 370 makes up the main portion of the vent assembly 358, i.e. is the main air intake area of the ventilation system 316. The vent body 370 can be fixedly secured to the foot bath 15 (illustrated in FIG. 1A) near the bath front 18A. As shown in FIG. 3B, the vent body 370 include an intake aperture 370A through which the air is directed into the vent body 370 before being directed through the conduit assembly 360. Additionally, the vent body 370 helps enable the desired coupling with the conduit assembly 360. More specifically, the vent body 370 can include an outlet aperture (not shown) that is coupled to the conduit assembly 360 to enable fluid communication between the vent assembly 358 and the conduit assembly 360. It is appreciated that the vent body 370 can have any suitable size and shape depending on the requirements of the salon treatment assembly 10 and/or the ventilation system 316.

The vent screen 372 is positioned over the intake aperture 370A of the vent body 370. The vent screen 372 is configured to inhibit larger items from being inserted into the vent assembly 358 and/or into the ventilation system 316.

The vent seal 374 provides a sealed coupling between the vent screen 372 and the vent body 370. More particularly, the vent seal 374 is positioned substantially between the vent screen 372 and the vent body 370 substantially adjacent to the intake aperture 370A. Alternatively, the vent seal 374 can be optional and the vent screen 372 can be secured to the vent body 370 without the seal therebetween. For example, the vent screen 372 can be secured to the vent body 370 with screens, magnets, or another type of fastener.

As noted above, the conduit assembly 360 provides an assembly through which the gases are guided from the front 18 of the foot bath system 14 through the salon treatment assembly 10, before being exhausted through the outlet 68 and away from the rear 62 of the salon treatment assembly 10 or elsewhere. In some embodiments, as shown in FIGS. 3A and 3B, the conduit assembly 360 includes a first conduit 364, a second conduit 366, a seal 376, a conduit support assembly 378 and a vent coupling assembly 380. Alternatively, the conduit assembly 360 can include more components or fewer components than what is specifically illustrated and described herein.

The first conduit 364 and the second conduit 366 are movably (slidingly) coupled to one another. In particular, in certain embodiments, the first conduit 364 and the second conduit 366 can be movably coupled to one another in a telescoping manner. Alternatively, the first conduit 364 and the second conduit 366 can be movably coupled to one another in another suitable manner.

As provided above, the first conduit 364 is coupled to the foot bath 15 and moves with the foot bath 15. Additionally, the second conduit 366 is coupled to the salon chair 12. With such design, during movement of the foot bath 15 relative to the salon chair 12, the second conduit 366 is fixed relative to the salon chair 12. However, the first conduit 364 moves relative to the second conduit 366 in such telescoping manner so as to adjust (extend or reduce) an overall length of the conduit assembly 360. Stated in another manner, as the foot bath 15 is selectively moved between the retracted configuration 21B and the extended configuration 21A, the first conduit 364 is moved relative to the second conduit 366 between the retracted position 69A (illustrated in FIG. 1D), wherein the second conduit 366 is positioned substantially inside the first conduit 364 (and the first conduit 364 substantially encircles the second conduit 366), and an extended position 69B (illustrated in FIG. 1E), wherein the first conduit 364 at least partly extends away from the second conduit 366. Alternatively, the conduit assembly 360 can be designed so that the second conduit 366 encircles the first conduit 364.

The size and shape of the first conduit 364 and the second conduit 366 can be varied. For example, in one non-exclusive embodiment, the first conduit 364 can be substantially cylindrical-shaped with a diameter of between approximately 4.5 and 5.5 centimeters; and the second conduit 366 can be substantially cylindrical-shaped with a diameter of between approximately 3.5 and 4.5 centimeters. With such design, the second conduit 366 can move telescopingly within the first conduit 364. Alternatively, the size and shape of the conduits 364, 366 can be different, and/or the first conduit 364 can be configured to move telescopingly within the second conduit 366.

The seal 376 (or sealing coupler) is positioned between the first conduit 364 and the second conduit 366 such that the first conduit 364 is movably and sealingly coupled to the second conduit 366. In one embodiment, the seal 376 can be a rubberized O-ring that enables such a movable and sealed relationship between the first conduit 364 and the second conduit 366. In this embodiment, the seal 376 fits in an annular shaped groove 366A at one end of the second conduit 366. With this design, the seal 376 fits between and slidingly seals the conduits 364, 366. Alternatively, the seal 376 can have another suitable design or can be positioned at a different location.

As provided herein, through the relative movement between the first conduit 364 and the second conduit 366, the conduit assembly 360 is able to maintain the desired coupling with the vent assembly 358 regardless of whether the foot bath system 14 is in the retracted configuration 21B or the extended configuration 21A.

The conduit support assembly 378 supports the first conduit 364 and the second conduit 366 relative to a base, e.g., relative to the movable base member 50 (illustrated in FIG. 1D). As shown, the conduit support assembly 378 can include at least one conduit support 382 (two are shown in the Figures), at least one brace 384 (two are shown in the Figures), and a plurality of attachers 386.

The conduit support(s) 382 can be secured to the movable base member 50 and can directly support the first conduit 364 relative to the movable base member 50. Additionally, the brace(s) 384 can be positioned to extend around the first conduit 364 and be secured to the conduit support(s), e.g., with the attachers 386, so as to secure the first conduit 364 to the conduit support(s) 382. With such design, the first conduit 364 can be fixedly coupled to and stabilized relative to the movable base member 50 so that the first conduit 364 moves with the movable base member 50 as the foot bath 15 moves between the extended configuration 21A and the retracted configuration 21B. Additionally, by fixedly coupling the first conduit 364 to the movable base member 50, the first conduit 364 can be selectively moved relative to the second conduit 366 between the extended position 69B and the retracted position 69A, as the foot bath 15 moves between the extended configuration 21A and the retracted configuration 21B.

The vent coupling assembly 380 provides a flexible assembly for coupling the first conduit 364 to the vent assembly 358. It is appreciated that the first conduit 364 can be coupled to the vent assembly 358 in any suitable manner. In some embodiments, as illustrated, the vent coupling assembly 380 can include a pair of elbow joints 388, i.e. a first elbow joint 388A and a second elbow joint 388B, a flexible conduit 390, a coupler 392 and a pair of hose clamps 394. Alternatively, the vent coupling assembly 380 can include more components or fewer components than what is specifically illustrated and described herein. It should be noted that the components of the vent coupling assembly 380 can be changed to suit the design of the foot bath 15 and the desired location of the vent inlet 316A.

The elbow joints 388 provide a desired redirectioning of the conduit assembly 360 between the vent assembly 358 and the first conduit 364. In certain embodiments, each of the elbow joints 388 can be angled at approximately ninety degrees. As shown, the first elbow joint 388A provides an approximately ninety degree coupling between the vent assembly 358, i.e. the vent body 370 via the outlet aperture, and the flexible conduit 390. Additionally, the second elbow joint 388B provides an approximately ninety degree coupling between the first conduit 364 and the flexible conduit 390 and/or the coupler 392.

The flexible conduit 390 is configured to provide any needed flexibility in the redirectioning of the conduit assembly 360 between the vent assembly 358 and the first conduit 364. More particularly, to the extent that there is any unanticipated relative movement between the first conduit 364 and the vent assembly 358, the flexible conduit 390 is configured to compensate for such unanticipated relative movement so that the desired coupling between the first conduit 364 and the vent assembly 358 can be effectively maintained.

The coupler 392 is configured to further stabilize the coupling between the flexible conduit 390 and the first conduit 364.

The hose clamps 394 are positioned at either end of the flexible conduit 390 for purposes of clamping the flexible conduit 390 to the elbow joints 388A, 388B and/or the coupler 392.

It is understood that although a number of different embodiments of the salon treatment assembly 10 have been illustrated and described herein, one or more features of any one embodiment can be combined with one or more features of one or more of the other embodiments, provided that such combination satisfies the intent of the present invention.

While a number of exemplary aspects and embodiments of a salon treatment assembly 10 have been discussed herein above, those of skill in the art will recognize certain modifications, permutations, additions and sub-combinations thereof. It is therefore intended that the salon treatment assembly 10 shall be interpreted to include all such modifications, permutations, additions and sub-combinations as are within their true spirit and scope, and no limitations are intended to the details of construction or design herein shown.

What is claimed is:

1. A salon treatment assembly for use by a user during a salon treatment, the salon treatment assembly comprising:
a salon chair that supports the user during the salon treatment; and
a foot bath system coupled to the salon chair, the foot bath system including (i) a foot bath that is configured to receive and retain a bath liquid, and (ii) a ventilation system that includes a vent inlet that is coupled to the foot bath, and a vacuum source that creates at least a partial vacuum in the vent inlet to draw gas away from near the foot bath.

2. The salon treatment assembly of claim 1 wherein there is relative movement between the salon chair and the foot bath between an extended configuration and a retracted configuration.

3. The salon treatment assembly of claim 2 the foot bath is movable relative to the salon chair between the extended configuration and the retracted configuration.

4. The salon treatment assembly of claim 3 further comprising a foot bath mover assembly that selectively moves the foot bath relative to the salon chair between the extended configuration and the retracted configuration.

5. The salon treatment assembly of claim 4 wherein the foot bath mover assembly includes (i) a guide that guides movement of the foot bath relative to the salon chair, and (ii) a mover that selectively moves the foot bath relative to the salon chair.

6. The salon treatment assembly of claim 2 wherein the ventilation system includes a retractable conduit assembly that connects the vent inlet to the vacuum source in fluid communication.

7. The salon treatment assembly of claim 6 wherein the foot bath includes a bath front and a bath rear, the bath rear being closer to the salon chair than bath front when the foot bath is in the extended configuration, and wherein the vent inlet is positioned adjacent to the bath front to draw gas into the vent inlet near the bath front.

8. The salon treatment assembly of claim 6 wherein the conduit assembly includes a first conduit that is coupled to the vent inlet, and a second conduit that is fixedly coupled to the salon chair, wherein the second conduit is coupled to the first conduit.

9. The salon treatment assembly of claim 8 wherein the conduit assembly is movable between an extended position when the foot bath is in the extended configuration, and a retracted position when the foot bath is in the retracted configuration.

10. The salon treatment assembly of claim 9 wherein one of the conduits slides relative to the other conduit in a telescoping manner.

11. The salon treatment assembly of claim 9 wherein the first conduit slides relative to the second conduit between the extended position and the retracted position.

12. The salon treatment assembly of claim 9 wherein the conduit assembly further includes a seal that seals the first conduit to the second conduit.

13. A method for supporting a user during a salon treatment, the method comprising:
providing a salon chair that supports the user during the salon treatment; and
coupling a foot bath system to the salon chair, the foot bath system including (i) a foot bath that is configured to receive and retain a bath liquid, and (ii) a ventilation system that includes a vent inlet that is coupled to the foot bath, and a vacuum source that creates at least a partial vacuum in the vent inlet to draw gas away from near the foot bath.

14. The method of claim 13 further comprising moving the foot bath relative to the salon chair between an extended configuration in which the foot bath is substantially uncovered by the salon chair, and a retracted configuration in which the foot bath is substantially covered by the salon chair.

15. The method of claim 14 further comprising connecting the vent inlet to the vacuum source with a retractable conduit assembly.

16. The method of claim 15 wherein the step of connecting includes the retractable conduit assembly including a first conduit that is coupled to the vent inlet, and a second conduit that is fixedly coupled to the salon chair, wherein one of the conduits slides relative to the other conduit in a telescoping manner.

17. A salon treatment assembly for use by a user during a salon treatment, the salon treatment assembly comprising:
a salon chair that supports the user during the salon treatment; and
a foot bath system coupled to the salon chair, the foot bath system including (i) a foot bath that is configured to receive and retain a bath liquid, and (ii) a ventilation system that includes a vent inlet that is coupled to the foot bath, and a vacuum source that creates at least a partial vacuum in the vent inlet to draw gas away from near the foot bath; wherein the foot bath is movable relative to the salon chair between an extended configuration in which the foot bath is substantially uncovered by the salon chair, and a retracted configuration in which the foot bath is substantially covered by the salon chair; and wherein the ventilation system includes a retractable conduit assembly that connects the vent inlet to the vacuum source in fluid communication while the foot bath is moved between configurations.

18. The salon treatment assembly of claim 17 wherein the foot bath includes a bath front and a bath rear, the bath rear being closer to the salon chair than bath front when the foot bath is in the extended configuration, and wherein the vent inlet is positioned adjacent to the bath front to draw gas into the vent inlet near the bath front.

19. The salon treatment assembly of claim 18 wherein the conduit assembly includes a first conduit that is coupled to the vent inlet, and a second conduit that is fixedly coupled to the salon chair, wherein the second conduit is coupled to the first conduit in a telescoping manner.

20. The salon treatment assembly of claim 19 wherein the first conduit slides relative to the second conduit.
